(19) United States
(12) Patent Application Publication
(10) Pub. No.: US 2020/0140252 A1
(43) Pub. Date: May 7, 2020

(54) TOOL FOR REMOVING LIDS WITH PULL TABS

(71) Applicants: Brian Miner, Framingham, MA (US); Donald Miner, Framingham, MA (US)

(72) Inventors: Brian Miner, Framingham, MA (US); Donald Miner, Framingham, MA (US)

(21) Appl. No.: 16/177,735

(22) Filed: Nov. 1, 2018

(51) Int. Cl. B67B 7/40; B65D 17/28

(52) U.S. Cl. CPC B67B 7/406; B65D 2517/0016; B65D 17/4011

(57) ABSTRACT

A tool for removing can lids having pull tabs is disclosed. The tool having an elongated member with a first end bent into a triangular-shaped handle and a second end bent into a U-shaped actuating member. Said actuating member having angles configured to receive a conventional pull tab container rim. A longitudinal portion of the tool having depressions and raised teeth configured to receive a pull tab ring therein. An object of the invention is to allow a user to easily open a can having a pull tab. Users first insert the device under the pull tab ring and pry it up. They remove and rotate the tool and reinsert it back into said pull tab ring and engage the actuating member onto the rim and also engage the teeth on said ring. They then pull up on the handle and obtain enough leverage to easily pry off the lid.

### BACKGROUND OF THE INVENTION

### 1. Field of the Invention

The present general inventive concept relates to a tool for removing container lids. More specifically, it relates to a tool for easily removing lids from containers with pull tabs.

### 2. Description of Related Art

Consumers purchase millions of food items stored in cans each year. When canning became popular a can opener was the only tool available to remove can lids. Decades later, manufacturers began installing pull tabs on lids allowing them to be easily removed without a can opener. However, removing these pull tabs can be difficult to operate for those with limited motor skill and can cause thumb, finger and hand pain to vulnerable consumers (such as the elderly and disabled). Many consumers do not possess the hand dexterity or strength to remove these pull tabs without an aid.

Therefore, what is desired is a simple tool that may be used to easily operate pull tabs to remove lids and provides a substitute for manual dexterity and hand strength.

### SUMMARY OF THE INVENTION

The present general inventive concept provides a tool for removing lids having pull tabs thereon.

The foregoing and/or other aspects of the present general inventive concept may be achieved by providing additional embodiments.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 illustrates a front perspective view of a pull tab removal tool according to an exemplary embodiment of the present general inventive concept;

FIG. 2 is a top plan view of the pull tab removal tool illustrated in FIG. 1;

FIG. 3 is a side view of the pull tab removal tool illustrated in FIG. 1;

FIG. 4 is a perspective view and a section view of a conventional container having a lid with a pull tab thereon.

FIG. 5 is a flowchart of a method of using the pull tab removal tool illustrated in FIG. 1;

FIG. 6 illustrates the pull tab removal tool shown in FIG. 1 with a section view of a conventional container shown in FIG. 4, according to an exemplary embodiment of the present general inventive concept;

FIG. 7 illustrates a section view of a conventional container having a lid with a pull tab tool inserted into the tab ring according to another exemplary embodiment of the present general inventive concept;

FIG. 8 is a section view of the pull tab removal tool prying a pull tab illustrated in FIG. 4;

FIG. 9 is a section view of the pull tab removal tool being threaded through a pried pull tab ring illustrated in FIG. 4;

FIG. 10 is a section view of the pull tab removal tool removing a lid using the pried pull tab ring; and

FIG. 11 is an enlarged view of the pull tab removal tool illustrated in FIG. 6.

### DESCRIPTION OF INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

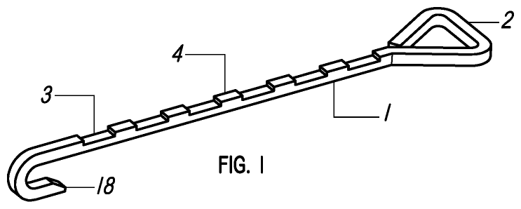

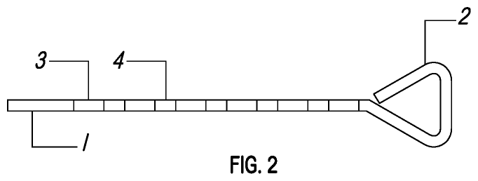

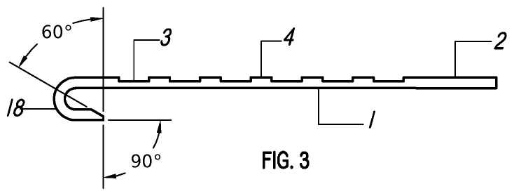

FIG. 1 illustrates a front perspective view of a pull tab removal tool 1 according to an exemplary embodiment of the present general inventive concept. FIG. 2 is a top plan view of the pull tab removal tool 1 illustrated in FIG. 1 and FIG. 3 is a side view of the pull tab removal tool 1 illustrated in FIG. 1. Referring to FIGS. 1 through 3, the pull tab removal tool, designated generally as 1, is illustrated. In the present embodiment, the pull tab removal 1 is designed and configured for operating pull tabs mounted on lids of conventional can containers. The pull tab removal tool 1 includes an elongated lever member having a first end handle 2 bent into a triangle shape and an opposing second end actuating member 18 having a ‘U’ shape. Said actuating member 18 having a first bend portion extending from the body member in a first direction perpendicular to the longitudinal axis and a second bend portion extending a second direction parallel to the body member. A distal portion of said actuating member 18 having one or more angled-portions thereon. A surface of the pull tab having a plurality of square-shaped, raised teeth 4 and depressions 3. In the present embodiment, the pull tab removal tool 1 may be formed from square shaped, rigid material such as, but not limited to metal wire, plastic and the like. However, the present general inventive concept is not limited thereto. That is, in alternative embodiments, the pull tab removal tool 1 may be formed from various shaped wire or materials.

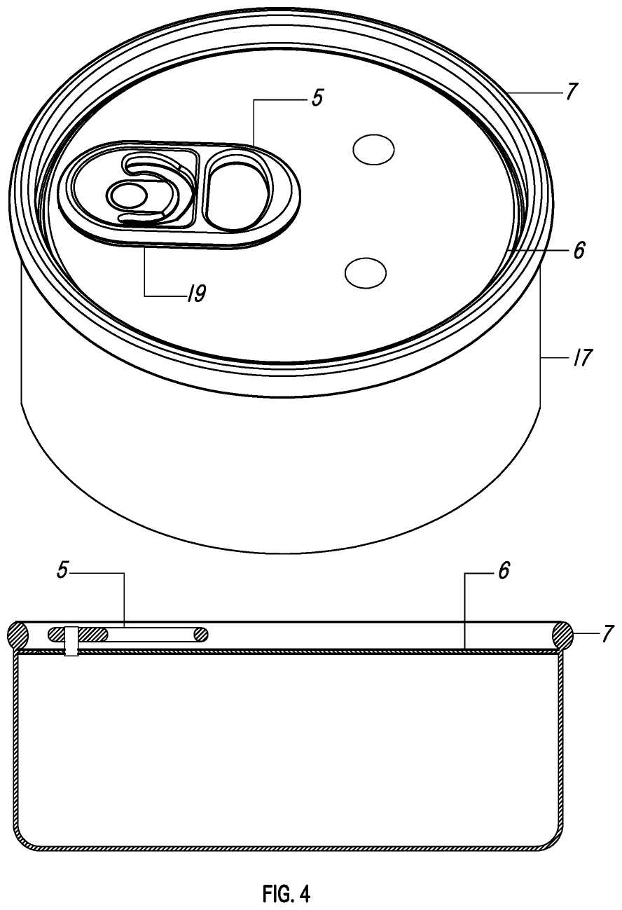

FIG. 4 is a perspective view and a section view of a conventional container having a lid with a pull tab thereon. The figure is illustrating a conventional cat food container 17 with pull tab 19 and pull tab ring 5 being pivotably connected to lid 6 as part of a cat food container 17.

In the present embodiment, the actuating member 18 may be formed in a U-shape to provide sufficient friction and/or grip when coupled against a container rim 7 which is used to pry up pull tab 19 with sufficient force to remove lid 6 from container 17. In particular, the pull tab removal tool 1 having raised teeth 4 and depressions 3 allowing it to be selectively engaged in pull tab ring 5 for leverage when prying said pull tab 19.

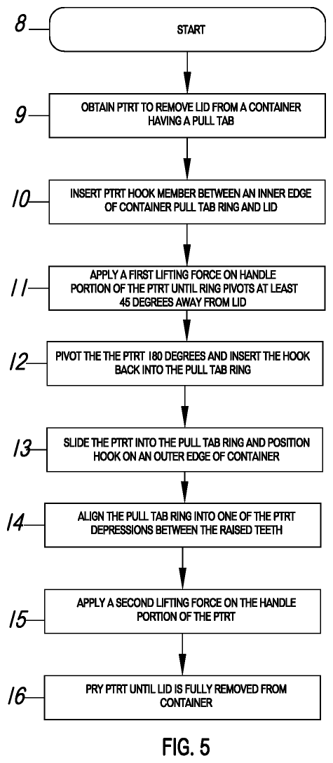

FIG. 5 is a flowchart of a method of using the pull tab removal tool 1 illustrated in FIG. 1.

Referring to FIG. 5, in the present exemplary embodiment, the method of using the pull tab removal tool 1 starts at step 8. At step 9 the pull tab removal tool 1 (abbreviated as PTRT) is obtained to remove lid 6 from a conventional can container 17.

Next, at step 10 the pull tab removal tool 1 actuating member 18 being inserted between pull tab ring 5 and container lid 6. However, the present general inventive concept is not limited thereto.

Next, at step 11, the user applies a first lifting force on handle 2 allowing the pull tab 19 to be raised away from lid between 5 degrees and 85 degrees and breaking said lid 6 seal away from rim 7.

Next, at step 12, the user removes the pull tab removal tool 1 from pull tab 19, pivoting it 180 degrees with hood 18 facing lid 6 and reinserting it back into pull tab 19.

Next, at step 13, the pull tab removal tool 1 being inserted until angled portions of actuating member 18 making contact with an underside of container rim 7.

Next, at step 14, the user aligns pull tab ring 5 with a depression 3 between two raised teeth 4 on the pull tab removal tool 1.

Next, at step 15, the user then applying a second lifting force on handle 2 allowing actuating member 18 to engage rim 7 and depression 3 to engage pull tab ring 5.

Finally, at stage 16, the pull tab removal tool being lifted away from container 17 and, using rim 7 as leverage against the lifting, fully removing lid 6.

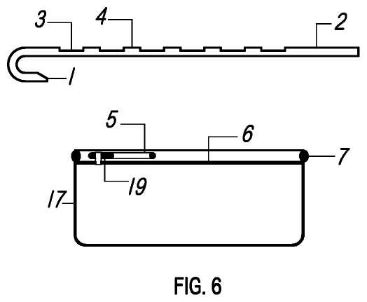

FIGS. 6 through 10 illustrate a method of using the pull tab removal tool 1 shown in FIG. 1 to remove lid 6 from the conventional container 17 shown in FIG. 4, according to an exemplary embodiment of the present general inventive concept. The conventional container 17 illustrated in FIG. 4 is only illustrative of one type of container shape. However, the pull tab removal tool 1 according to the present general inventive concept may be used to remove lids from various other sizes of containers having different diameter sizes and shapes.

In operation, the pull tab removal tool 1 is configured and designed to be a hand tool. However, the present general inventive concept is not limited thereto. That is, in alternative embodiments, the pull tab removal tool 1 may be incorporated within a system which provides mechanical assistance in generating the required force to remove said lid 6.

According to an exemplary embodiment, the pull tab removal tool 1 may be used to remove a lid 6 from conventional container 17 as follows.

Referring to FIG. 6, illustrates a container 17 having lid 6 fixedly connected to pull tab 19 that is to be pried away from container 17 in order to open said container 17.

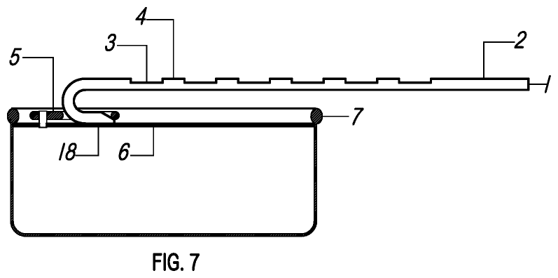

Referring now to FIGS. 7 through 10, the user may insert the pull tab removal tool into the pull tab ring by first gaining access to said ring. In order to gain such access, the actuating member 18 being inserted between pull tab ring 5 and lid 6 and the handle 2 being pried upwards. Once the pull tab ring being pried between 5 degrees and 85 degrees away from the lid 6, access is then allowed for pull tab removal tool 1 insertion to take place. The user then rotating the pull tab removal tool 1 and reinserting the actuating member 18 end first into the pull tab ring 5 until the angled members of actuating member 18 making contact with the under portion of rim 7 and depression 3 being engaged with said tab ring 5. The user then pulling upwards on handle 2 with rim 7 providing leverage and removing lid 6 completely from conventional container 17 therefrom.

FIG. 7 illustrates a section view of a conventional container having a lid 6 with the actuating member 18 end of pull tab tool 1 inserted into the tab ring 5 with angled portions engaging said pull tab ring 5 according to another exemplary embodiment of the present general inventive concept;

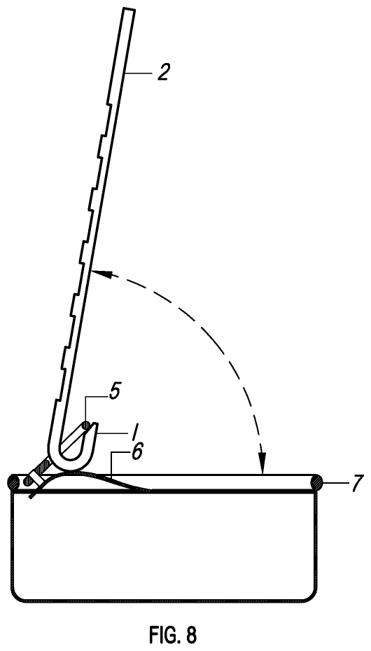

FIG. 8 is a section view of the pull tab removal tool 1 having a force applied by a user prying a pull tab 18 illustrated in FIG. 4;

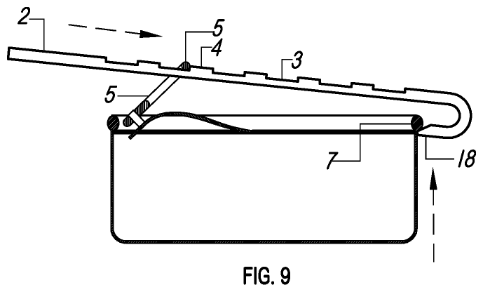

FIG. 9 is a section view of the pull tab removal tool 1 being threaded through a pried pull tab ring 5 illustrated in FIG. 4 and the actuating member end 18 engaging rim 7 thereunder providing a leverage point;

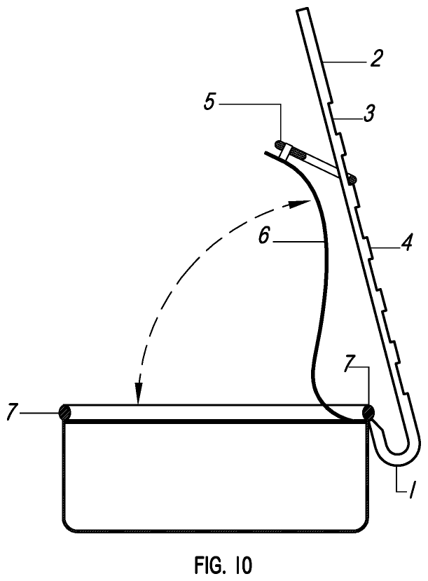

FIG. 10 is a section view of the pull tab removal tool 1 being pried a final time and removing a lid 6 by means of the pried pull tab 19; and;

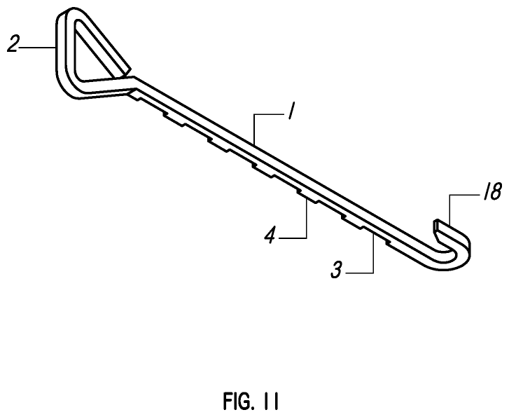

FIG. 11 is an enlarged bottom perspective view of the pull tab removal tool 1 illustrated in FIG. 6 illustrating the actuating member 18 end.

Referring to FIG. 1, FIG. 2 and FIG. 3 the pull tab removal tool 1 was formed from square wire. Pull tab removal tool 1 illustrated in FIGS. 6 through 10 is substantially similar to the previous embodiment.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A device for opening a container having a pull tab, the device comprising:
a body member having a longitudinal axis, a first end, and an opposing second end;
an actuating member defined at the first end of the body member, the actuating member having a first bend portion extending from the body member in a first direction perpendicular to the longitudinal axis and a second bend portion extending a second direction parallel to the body member; and
a handle member defined at the second end of the body member, wherein the bend portion is configured to generate leverage against the container to open the pull tab, when a first force is applied to the handle member.

2. The device of claim 1, wherein the actuating member is formed in a U-shape forming an open slot and terminating at an actuating face.

3. The device of claim 2, wherein the actuating face includes a first portion inclined with respect to the body member and a second portion substantially perpendicular to the body member.

4. The device of claim 3, wherein the first portion of the actuating face is inclined at an angle between 5 degrees and 85 degrees.

5. The device of claim 3, wherein the second portion includes at least one flat portion configured to grip a surface of the pull tab of the container.

6. The device of claim 1, wherein the body member includes a length between 2 inches and 10 inches.
